(19) United States
(12) Patent Application Publication
(10) Pub. No.: US 2009/0289006 A1
(43) Pub. Date: Nov. 26, 2009

(54) Filter Unit

(76) Inventors: Yoshinori Nakajima, Nara-Shi (JP); Toshiyuki Tanaka, Hirakata-shi (JP); Hirotugu Matoba, Sakurai-shi (JP)

Correspondence Address: EDWARDS ANGELL PALMER & DODGE LLP, P.O. BOX 55874, BOSTON, MA, 02205, US

(21) Appl. No.: 12/086,347

(22) PCT Filed: Dec. 14, 2006
(86) PCT No.: PCT/JP2006/324921

§ 371 Date: Jun. 11, 2008

(30) Foreign Application Priority Data
Dec. 15, 2005 (JP) 2005-361632

(51) Int. Cl. B01D 35/30

(52) U.S. Cl. 210/450

(57) ABSTRACT

A filter unit (3) includes a housing (161), a housing (162), a filter member (164), and a packing (165A). The housings (161) and (162) are joined to each other liquid-tightly. The filter member (164) and the packing (165A) are disposed so as to be sandwiched between the housing (161) and the housing (162). The housing (161) is formed with a projection (167) located outside a portion of the housing (161) which is contacted by the O-ring. The housing (162) is formed with a recess (166) for receiving the projection (167) therein. A sealing material (168) is provided between the projection (167) and the recess (166).

### TECHNICAL FIELD

The present invention relates to a filter unit for filtration of liquid and, more particularly, to a filter unit for use in a droplet jet device.

### BACKGROUND ART

A droplet jet device includes a droplet jet unit configured to jet droplets through plural nozzles. The droplet jet unit is supplied with liquid from a liquid storage section. Usually, a filter unit is disposed intermediate the droplet jet unit and the liquid storage section. The filter unit filters liquid flowing between the liquid storage section and the droplet jet unit.

One typical filter unit configuration comprises two housing members liquid-tightly joined to each other, and a filter member sandwiched between the housing members. As methods of fixing the filter member to the housing members, use has been frequently made of: a method including bonding an outer peripheral portion of the filter member to the housing members by using adhesive; a method including thermal welding or ultrasonic welding an outer peripheral portion of the filter member to the housing members; and a method including using a packing for pressing the filter member against the filter members. The degree of difficulty in assembling the filter unit differs according to which one of these methods is used. For example, as is often the case with the method of fixing the filter member using a packing, the assemblage of the filter unit is relatively easy. This is because the packing deforms elastically so as to absorb unevenness in the finishing precision of the housing members or in the thickness of the filter member. One conventional art adopts an arrangement using a packing which presses against the filter member to fix the filter member, and another packing for sealing the joint portion of the two housing members (see patent document 1 for example).

Patent document 1: Japanese Utility Model Laid-Open Publication No. HEI 2-95508

### DISCLOSURE OF INVENTION

### Problem to be Solved by Invention

The filter holder described in patent document 1, however, has a possibility of liquid leakage from between the housing members because only the packing seals the joint portion of the housing members. The occurrence of liquid leakage lowers the reliability of the filter unit considerably and, hence, it is critical to prevent the occurrence of liquid leakage reliably.

It is an object of the present invention to provide a filter unit which is capable of being assembled easily so as to prevent the occurrence of liquid leakage therefrom.

### Means for Solving Problem

A filter unit according to the present invention is a filter unit for filtering liquid passing therethrough, which includes a first housing member, a second housing member, a filter member, and an O-ring. The first and second housing members each have a bottomed tubular shape. The first and second housing members are joined to each other liquid-tightly. The filter member is disposed so as to be sandwiched between the first housing member and the second housing member. The O-ring is disposed so as to be sandwiched, together with the filter member, between the first housing member and the second housing member while contacting an end portion of the filter member.

The first housing member is formed with an annular projection located outside a portion of the first housing member which is contacted by the O-ring. The second housing member is formed with an annular recess located to face the projection of the second housing for receiving the projection therein. A sealing material is provided between the projection and the recess.

In this configuration, the O-ring deforms elastically to absorb unevenness in the finishing precision of the housing members or in the thickness of the filter member. For this reason, even when the finishing precision of each member is not very strict, any trouble is not likely in assembling the filter unit. This results in easy assemblage of the filter unit. Further, the provision of the sealing material between the housing members makes it easy to prevent leakage of liquid from between the housing members. What is more, since the filter member presses against only one of the housing members, the finishing precision required of the housing members may be lower than that required of the housing members in an arrangement wherein the filter member presses against both of the housing members.

### ADVANTAGE OF INVENTION

According to the present invention, the filter unit can be assembled easily so as to prevent the occurrence of liquid leakage therefrom.

### BRIEF DESCRIPTION OF DRAWINGS

FIG. 1 is a perspective view showing an ink-jet head according to an embodiment of the present invention.

FIG. 2 is a perspective view showing a base unit.

FIG. 3 is an exploded view schematically showing the configuration of the base unit.

FIG. 4 is a view showing the configurations of a head base, chip mount and head chip.

FIG. 5 is a perspective view showing the configuration of the head chip.

FIG. 6 is a perspective view showing the configuration of a filter unit.

FIG. 7 is a perspective view showing the configuration of a filter unit.

FIG. 8 is a view showing the base unit and the filter unit in a disassembled state;

FIG. 9 is a view showing the base unit and the filter unit in an assembled state.

FIG. 10 is a view schematically showing the configuration of the ink-jet head.

FIG. 11 is a perspective view showing the configuration of a filter unit.

FIG. 12 is a perspective view showing the configuration of a filter unit.

### DESCRIPTION OF REFERENCE CHARACTERS

1 ink-jet head
3 filter unit
161, 162 housing member
164 filter member
165A, 165B, 165C packing
166 recess
167 projection
168 adhesive

### BEST MODE FOR CARRYING OUT THE INVENTION

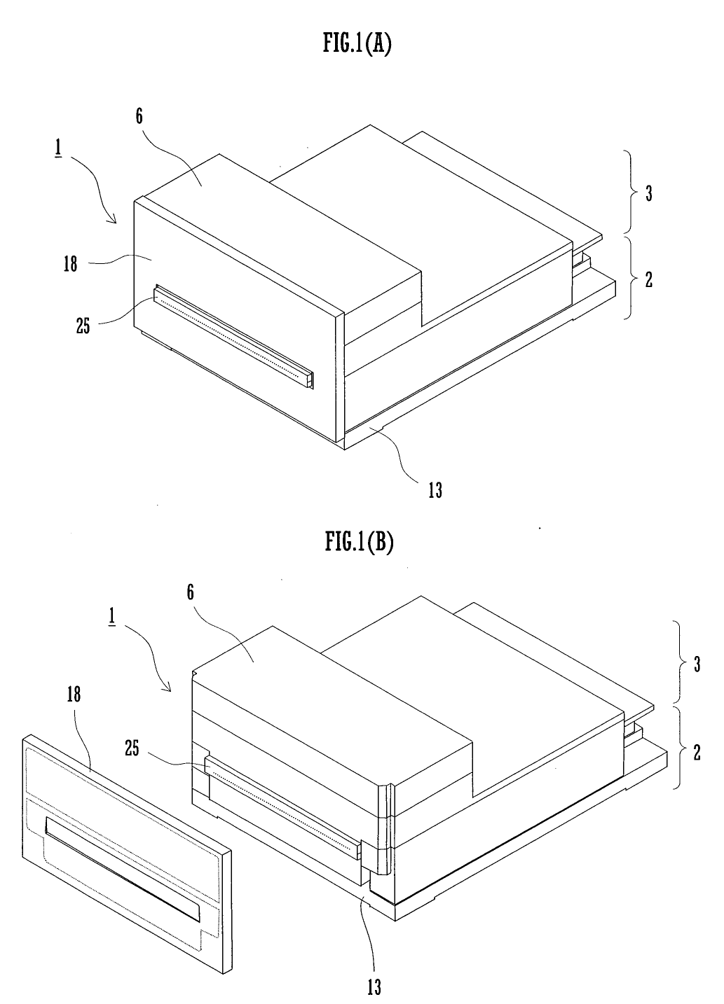

FIGS. 1(A) and 1(B) show an ink-jet head 1 incorporating therein a filter unit according to the present invention. The ink-jet head 1 includes a cover member 18, a base unit 2, and a filter unit 3. The cover member 18 is disposed so as to cover surfaces of the base unit 2 and filter unit 3 on an ink jetting side. FIG. 1(A) shows a state in which the cover member 18 is fitted on the base unit 2 and filter unit 3, while FIG. 1(B) shows a state in which the cover member 18 is detached from the base unit 2 and filter unit 3.

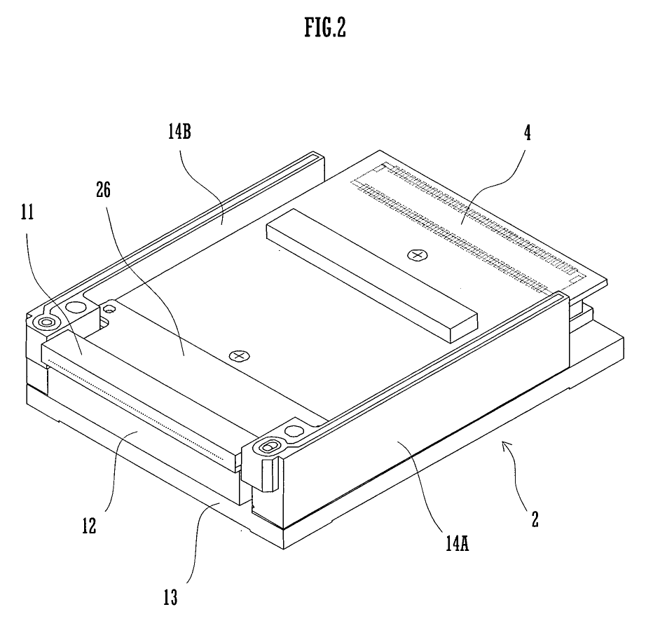

The configuration of the base unit 2 will be described with reference to FIGS. 2 to 5. As shown in FIG. 2, the base unit 2 is basically line-symmetric. The base unit 2 includes a head base 13, chip mount 12, head chip 11, flexible board 26, driver board 4, and manifolds 14A and 14B.

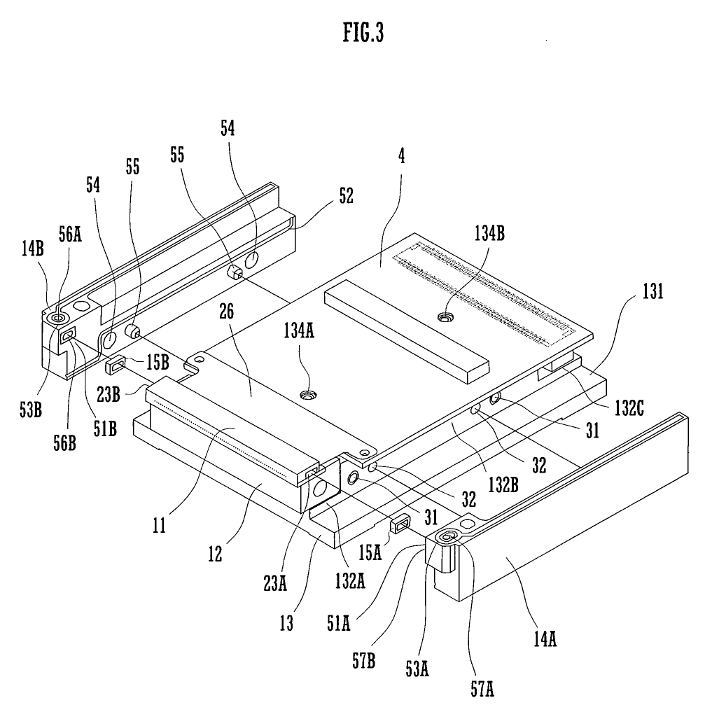

The head base 13 is formed from a metallic material. In the present embodiment, SUS (having a linear expansion coefficient of about 11×10⁻⁶ m/K) is used as the material of the head base 13. As shown in FIG. 3, the head base 13 is formed with a protruding mount portion 131 on a surface thereof and has an inverted T-shaped section. The mount portion 131 is formed in a transversely (hereinafter will be referred to as “widthwise”) central portion of the head base 13 and extends longitudinally (hereinafter will be referred to as “lengthwise”) of the head base 13. In the mount portion 131, first to third mounts 132A, 132B and 132C are arranged in the lengthwise direction.

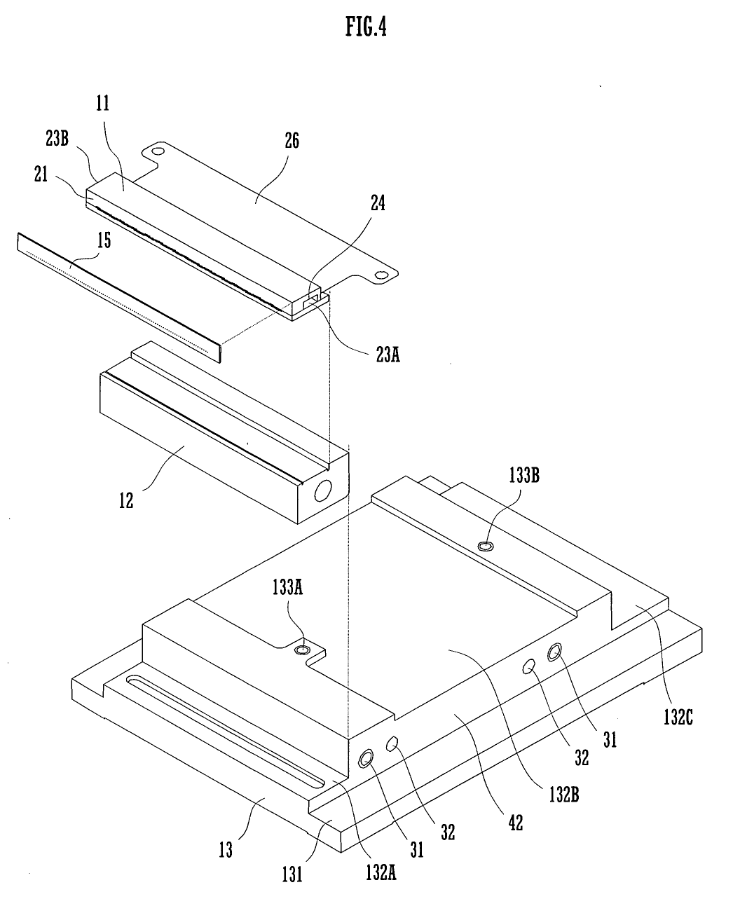

As shown in FIG. 4, the chip mount 12 is bonded to the first mount 132A by means of adhesive. The chip mount 12 is formed from alumina (having a linear expansion coefficient of about 4×10⁻⁶ m/K). The head chip 11 is bonded to the chip mount 12 by means of the adhesive. In the present embodiment, the adhesive used is an epoxy adhesive. However, there is no limitation to the type of adhesive used in the present embodiment. In the present embodiment, any one of the first, second and third mounts 132A, 132B and 132C has a width of 12 mm, the chip mount 12 has a width of 11.5 mm, and the head chip 11 has a width of 12 mm. In fixing the chip mount 12 to the first mount 132A, the chip mount 12 is positioned in such a manner that widthwise opposite ends of the chip mount 12 are each retreated by about 0.25 mm from a respective one of widthwise opposite ends of the first mount 132A. At that time, the widthwise opposite end faces of the head chip 11 are positioned substantially coplanar with respective of widthwise opposite end faces of each of the first to third mounts 132A, 132B and 132C.

Each of the widthwise opposite end faces of the second mount 132B has plural internal thread portions 31 and plural positioning holes 32. The driver board 4 is mounted on the second mount 132B. The surface of the second mount 132b on which the driver board 4 is mounted is formed with tapped holes 133A and 133B. The driver board 4 is fixed to the second mount 132B by thrusting screws 134A and 134B into the respective tapped holes 133A and 133B through respective holes defined by the driver board 4. The driver board 4 is connected to the head chip 11 via the flexible board 26.

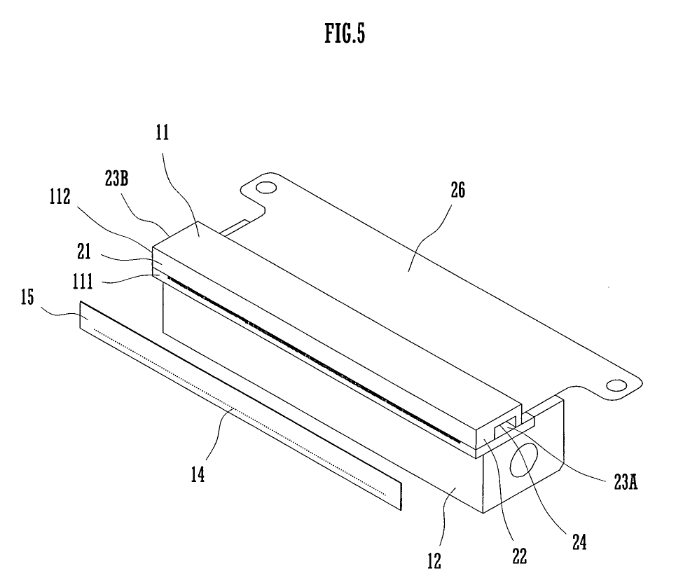

FIG. 5 is a view showing the configurations of the chip mount 12, head chip 11 and flexible board 26.

The head chip 11 includes two piezoelectric substrates 111 and 112 superposed on each other, each of which comprises lead zirconium titanate (PZT) having a linear expansion coefficient ranging from 2×10⁻⁶ to 7×10⁻⁶ m/K.

The piezoelectric substrate 111 is polarized and formed with a plurality of parallel grooves at a surface to face the piezoelectric substrate 112. A sidewall surface of each of the plural grooves is formed with a driving electrode. On the other hand, the piezoelectric substrate 112 is not polarized and is bonded to the groove forming surface side of the piezoelectric substrate 111. The piezoelectric substrate 112 is formed with a groove 24 extending over the entire width thereof and has a substantially inverted U-shaped section. When the piezoelectric substrates 111 and 112 are bonded together, the plural grooves of the piezoelectric substrate 111 each form a respective one of individual liquid chambers, while the groove 24 of the piezoelectric substrate 112 forms a common liquid chamber. The individual liquid chambers, common liquid chamber and the exterior of the head chip 11 are coated with a protection film by parylene coating.

The groove 24 appears as a liquid introduction port 23A at a widthwise first lateral side of the head chip 11. The groove 24 appears also as a liquid discharge port 23B at a widthwise second lateral side of the head chip 11 which is opposite away from the first lateral side. As a result, the liquid introduction port 23A and the liquid discharge port 23B communicate with each other through the common liquid chamber formed inside the head chip 11.

When the piezoelectric substrates 111 and 112 are superposed on each other, the plural grooves of the piezoelectric substrate 111 are exposed at an ink jetting side. A nozzle plate 15 comprising a polyimide film is bonded to the ink jetting side. The nozzle plate 15 has plural nozzle openings 14 arranged with the same pitch as the plural grooves of the piezoelectric substrate 111.

The head chip 11 has connecting electrodes on the side opposite away from the ink jetting side, each of which is led out of a respective one of the plural individual liquid chambers. The connecting electrodes are electrically connected to the flexible board 26 through ACF (anisotropic conductive film).

Referring again to FIG. 3, description will be made of the manifolds 14A and 14B. For convenience of description, a surface of the manifold 14A that faces the base unit 2 will be referred to as “internal surface of the manifold 14A” and, likewise, a surface of the manifold 14B that faces the base unit 2 will be referred to as “internal surface of the manifold 14B”.

The manifolds 14A and 14B are formed from PEEK (polyether ether ketone). The manifolds 14A and 14B are symmetric with respect to each other. The manifolds 14A and 14B each define therein a liquid flow path to become continuous with the common liquid chamber. The liquid flow path in the manifold 14A extends between a first opening 57A and a second opening 57B. Likewise, the liquid flow path in the manifold 14B extends between a first opening 56A and a second opening 56B. The second opening 57B of the manifold 14A is positioned coincidentally with the liquid introduction port 23A. A recess 51A is formed around the second opening 57B. Similarly, the second opening 56B of the manifold 14B is positioned coincidentally with the liquid discharge port 23B. A recess 51B is formed around the second opening 56B. In the present embodiment, the recesses 51A and 51B are each 0.8 mm deep.

The internal surfaces of the respective manifolds 14A and 14B are each formed with plural throughholes 54 and plural positioning pins 55. Further, the internal surfaces of the respective manifolds 14A and 14B are each formed with a V-groove 52. In mounting the manifolds 14A and 14B on the base unit 2, each V-groove 52 is coated with an epoxy adhesive.

In mounting the manifolds 14A and 14B on the base unit 2, an elastic seal member 15A is disposed between the second opening 57B and the liquid introduction port 23A and, similarly, an elastic seal member 15B disposed between the second opening 56B and the liquid discharge port 23B. In the present embodiment, the elastic seal members 15A and 15B each comprise a frame-like packing of perfluoro rubber. The elastic seal members 15A and 15B are each designed to have a hollow region having a size (2.4×1.1 mm) equal to the opening size of each of the liquid introduction port 23A and the liquid discharge port 23B. The elastic seal members 15A and 15B are fitted into the recesses 51A and 51B, respectively. The elastic seal members 15A and 15B each have a thickness of 1.1 mm, which is larger by about 0.3 mm than the depth of the recesses 51A and 51B. For this reason, the elastic seal members 15A and 15B are deformed elastically by compression when the manifolds 14A and 14B are mounted on the base unit 2. The elastic seal members 15A and 15B provide communication between the liquid flow path defined in the manifold 14A and the common liquid chamber and between the liquid flow path defined in the manifold 14B and the common liquid chamber. The elastic seal members 15A and 15B used here each produce a repulsion force of about 9.8 N when compressed by 0.3 mm.

In mounting the manifolds 14A and 14B on the base unit 2, the plural positioning pins 55 are each fitted into a respective one of the plural positioning holes 32. Further, by fitting screws into respective of the plural internal thread portions 31 through respective of the plural throughholes 54, the manifolds 14A and 14B are fixed to the base unit 2.

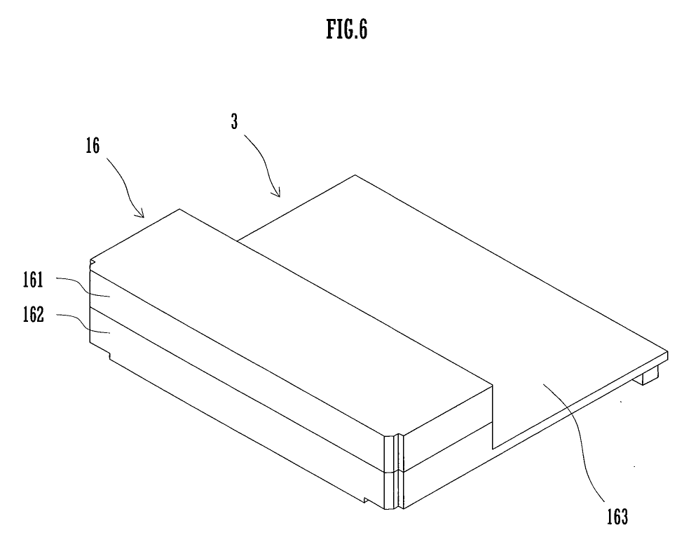

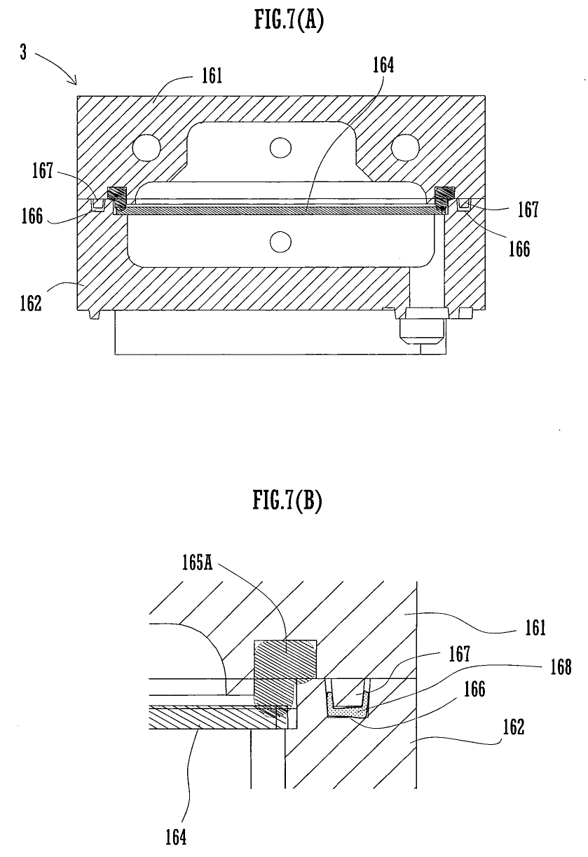

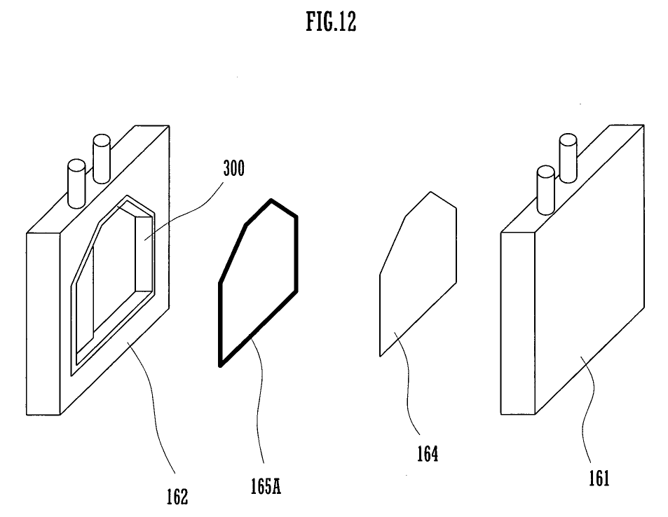

The configuration of the filter unit 3 will be described with reference to FIGS. 6 and 7. The filter unit 3 includes two housings 161 and 162 each having a bottomed rectangularly tubular shape which is open on one side. The filter unit 3 of this configuration has a bottomed prismatic recess 300 as shown in FIG. 12.

The housings 161 and 162 are each formed from PEEK (polyether ether ketone). The housings 161 and 162 are joined together with their open sides mated to each other. A filter plate 164 is disposed so as to be sandwiched between the housings 161 and 162.

The housing 161 is formed with an annular groove 169 for receiving an annular packing 165A therein. The provision of the groove 169 makes it easy to position the packing 165A. The groove 169 according to the present embodiment forms a retainer portion defined by the present invention.

The packing 165A has a substantially L-shaped section. This shape is adopted because the portion of the packing 165A which contacts the filter plate 164 is made thicker so that the packing 165A presses against the filter plate 164 more strongly. As a result, the filter plate 164 can be fixed reliably and easily. Also, the packing 165A can easily absorb unevenness in the finishing precision of the housings 161 and 162 or in the thickness of the filter plate 164 by its elastic deformation.

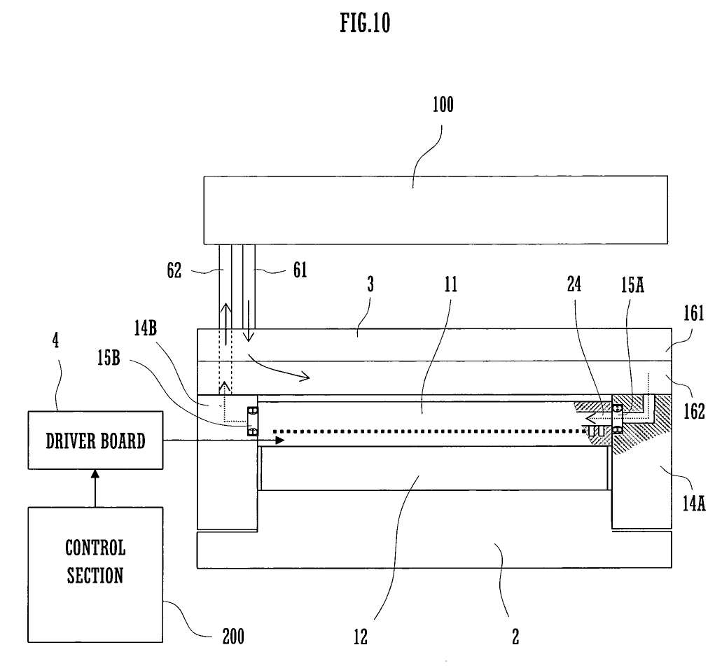

In the present embodiment, perfluoro rubber is used as the material of the packing 165A. The housing 161 has a liquid chamber formed with an introduction port for introducing liquid from a liquid storage section 100 (see FIG. 10) to be described later.

By using PEEK (polyether ether ketone) and perfluoro rubber as the material of the housings 161 and 162 and the material of the packing 165A, respectively, the filter unit 3 having a superior chemical resistance can be assembled.

The housing 162 is formed with an annular filter support portion 170 for supporting an end portion of the filter plate 164. Within the liquid chamber of the housing 162, there is formed a flow path to communicate with the first opening 57A of the manifold 14A. Further, the housing 162 is formed with a non-illustrated vent flow path to communicate with the first opening 56A of the manifold 14B. The vent flow path is connected to the liquid storage section 100 through a vent flow path formed in the housing 161.

The housing 161 is formed with a projection 167 located outside the portion thereof which is contacted by the packing 165A. The housing 162 is formed with a recess 166 to receive the projection 167 therein. A sealing material 168 is provided between the projection 167 and the recess 166.

Usually, it is difficult for a high-melting-point and high-viscosity resin, such as PEEK, to allow the filter plate 164 to be fixed to the housings 161 and 162 by thermal welding. However, with the above-described configuration wherein the filter plate 164 is fixed by means of the packing 165A and liquid leakage is prevented by means of the sealing material, the filter unit 3 can be constructed using PEEK.

The packing 165A comprises a filter fixing portion contacting the end portion of the filter plate 164, and a sealing portion which is continuous with the filter fixing portion. The sealing portion is positioned to extend outwardly along the interface between the housings 161 and 162. That is, the sealing portion is pressure-contacted directly by the housings 161 and 162. As a result, the packing 165A seals a portion extending between the portion provided with the sealing material 168 and the region in which the filter plate 164 is disposed. Since the interface between the housings 161 and 162 is double-sealed by the sealing portion of the packing 165A and the sealing material, the occurrence of liquid leakage can be prevented easily. Also, even when the sealing material 168 flows out from between the projection 167 and the recess 166 because of excessive use of sealing material 168, the presence of the sealing portion makes it possible to prevent an excess of the sealing material 168 thus flowing out from reaching the filter plate 164. As a result, the filter member can be prevented from being clogged with the sealing material 168.

Further, since the sealing of the portion extending between the portion provided with the sealing material 168 and the region in which the filter plate 164 is disposed is enhanced, it is not likely that the liquid inside the filter unit 3 and the sealing material 168 contact each other. For this reason, it is not likely that limitation is imposed on materials that can be used for the sealing material 168 depending on the type of liquid present inside the filter unit 3, or limitation is imposed on liquids that can be filtered inside the filter unit 3 depending on the type of sealing material 163 to be used.

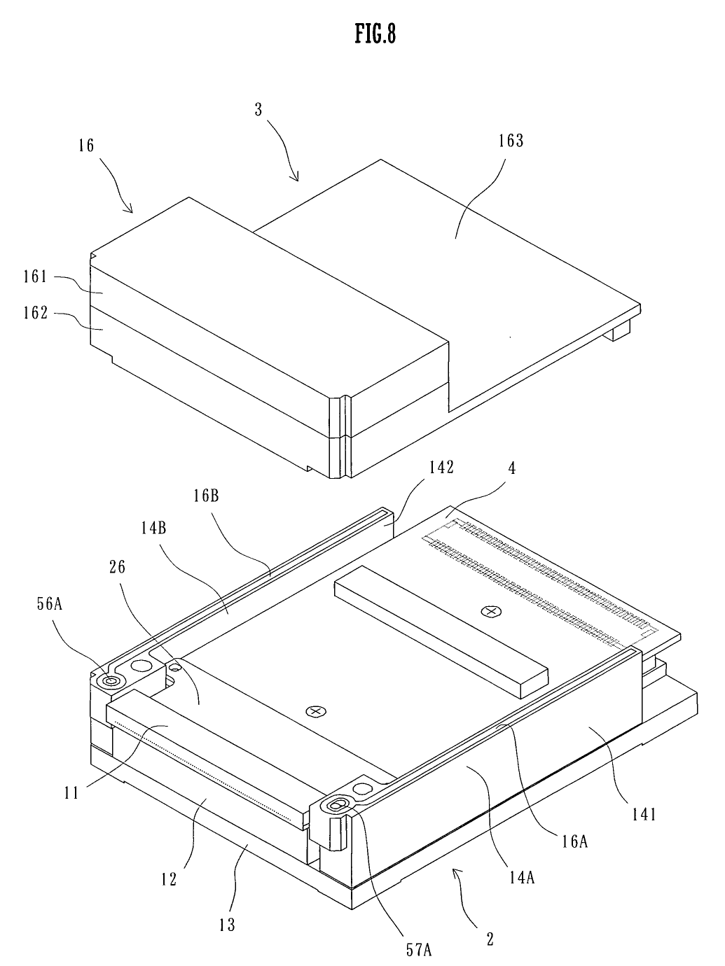

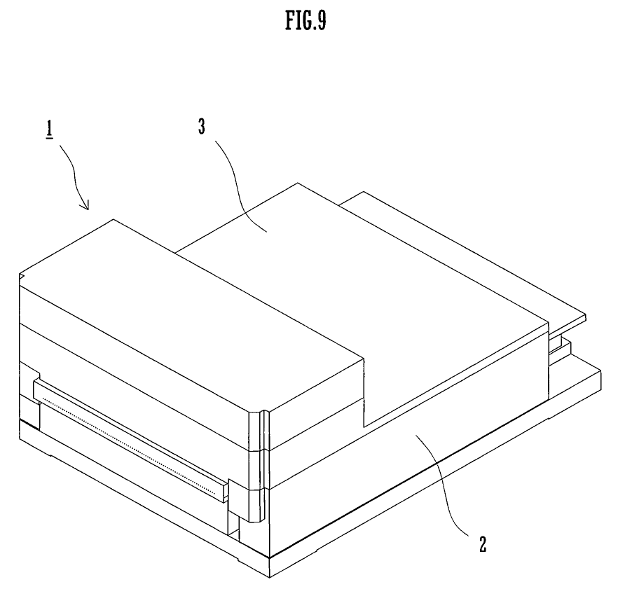

As shown in FIG. 8, the manifolds 14A and 14B are formed with grooves 16A and 16B, respectively. The grooves 16A and 16B are filled with adhesive when the manifolds 14A and 14B and the filter unit 3 are to be attached to each other. The adhesive used in the grooves 16A and 16B preferably has a linear expansion coefficient close to that of the material of the manifold 14A and 14B and filter unit 3. In the present embodiment, the grooves 16A and 16B are filled with an epoxy adhesive. FIG. 9 shows a state in which the filter unit 3 and the manifolds 14A and 14B are bonded together by means of the adhesive.

FIG. 10 is a view schematically showing the configuration of the ink-jet head 1. In the hatched portion shown in FIG. 10, a part of the liquid flow path is shown in section. As already described, the chip mount 12 has a smaller width than the head chip 11 and the mount 131 of the head base 13. Therefore, gaps are defined respectively between the chip mount 12 and the manifold 14A and between the chip mount 12 and the manifold 14B. For this reason, even when the amount of the adhesive used to bond the head chip 11 to the chip mount 12 or the amount of the adhesive used to bond the chip mount 12 to the head base 13 is excessive, the excess of the adhesive can be absorbed by the aforementioned gaps. As a result, the adhesive fails to flow in between the head chip 11 and the manifolds 14A and 14B and between the head base 13 and the manifolds 14A and 14B.

In the present embodiment, the head chip 11 and the manifolds 14A and 14B are not fixed directly to each other. For this reason, a frictional force can be produced between the head chip 11 and the chip mount 12 by repulsion forces of the elastic seal members 15A and 15B working on the head chip 11. However, since the forces of the elastic seal members 15A and 15B work on the head chip 11 in opposite directions to cancel each other, such a frictional force produced between the head chip 11 and the chip mount 12 can be minimized.

In the construction described above, the liquid is supplied from the liquid storage section 100 into the housing 161 through a tube 61 during an initial liquid charging stage. The liquid thus supplied into the housing 161 is filtered by passing through the filter plate before introduction into the housing 162. The liquid is then guided from the housing 162 to the common liquid chamber of the head chip 11 through the manifold 14A. Further, the liquid having passed through the common liquid chamber returns to the liquid storage section 100 by passing through the flow path defined within the manifold 14B, vent flow paths formed in the housings 161 and 162, and a tube 62. As the liquid circulates, residual air present within the common liquid chamber is removed. When the removal of residual air is completed, the return path intermediate the manifold 14B and the liquid storage section 100 is shut off by means of a non-illustrated valve. Thereafter, a control section 200 controls the driver board 4 so as to drive the driving electrodes in the respective individual liquid chambers of the head chip 11. Thus, the head chip 11 jets the liquid.

As described above, the ink-jet head 1 according to the present embodiment has a merit that residual air present within the common liquid chamber can be discharged efficiently by circulating the liquid through the liquid storage section 100, filter unit 3 and head chip 11. Further, since the head chip 11 is provided with the liquid introduction port 23A and liquid discharge port 23B, the liquid circulating path can be formed easily.

The arrangement for circulating the liquid through the liquid introduction port 23A and liquid discharge port 23B need not necessarily be employed.

For example, it is possible to employ an arrangement wherein: in the initial stage of charging the liquid into the head chip 11, the liquid is introduced from the liquid introduction port 23A side and then discharged through a drain (not shown) in communication with the liquid discharge port 23B; and the drain in communication with the liquid discharge port 23B is shut off after the removal of residual air. Such an arrangement also makes it possible to efficiently discharge residual air together with discharged liquid. In addition, this arrangement can further simplify the flow path while ensuring the residual air removal capability, thereby making it possible to reduce the device manufacturing cost.

Referring again to FIG. 8, description will be made of another merit of the ink-jet head 1 according to the present embodiment. As shown, the driver board 4 and flexible board 26 on the head base 13 are covered with the manifolds 14A and 14B and filter unit 3. Specifically, the driver board 4 is protected by being substantially entirely covered with a plate portion 163 extending from the housings 161 and 162, a plate portion 141 extending from the flow path forming portion of the manifold 14A, and a plate portion 142 extending from the flow path forming portion of the manifold 14B. For this reason, the driver board 3 is prevented from damage due to liquid splashed thereon. Further, the driver board 4 is protected with such indispensable members as the manifolds 14A and 14B and the filter unit 3 and, hence, there is no need to provide a separate member for merely protecting the driver board 4. Thus, the number of constituents can be reduced.

As also shown in FIG. 8, the manifolds 14A and 14B located on the opposite sides of the head chip 11 are coupled to each other by the filter unit 3, to form a gate-shaped structure as a whole. With such a structure, the flow path forming portions have an increased rigidity. For this reason, the flow path is not prone to damage even when the repulsion forces of the elastic seal members 15A and 15B or an external force from the outside is exerted thereon.

While the foregoing embodiment uses the packing 165A having a substantially L-shaped section, packings having the following shapes may be used.

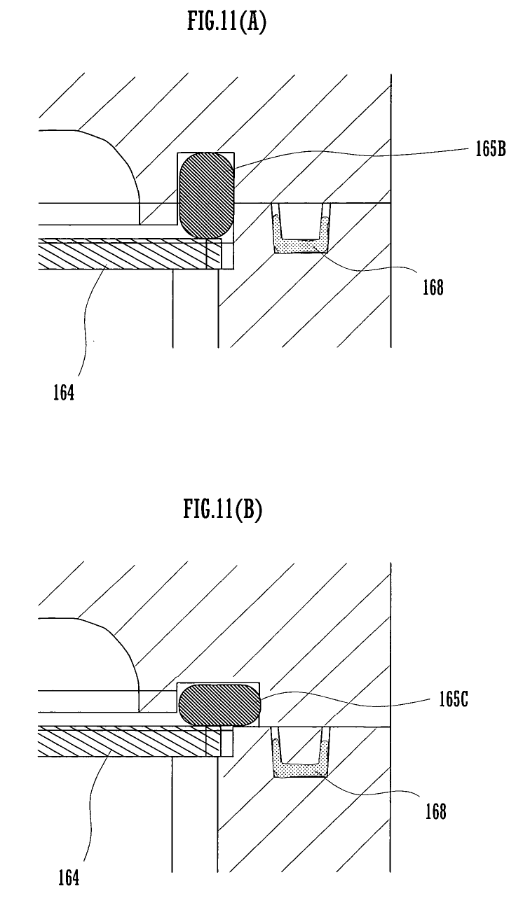

FIG. 11(A) shows an embodiment using a packing 165B having a vertically elongated shape. In this embodiment, the packing 165B functions solely to fix the filter plate 164.

FIG. 11(B) shows an embodiment using a packing 165C having a horizontally elongated shape. In this embodiment, the packing 165C fulfills both of the function of fixing the filter plate 164 and the function of sealing the interface between the housings 161 and 162. The packing 165C does not strongly press against the filter plate 164 and hence deforms not very largely. For this reason, deformation of the packing 165 does not interfere with the sealing of the interface between the housings 161 and 162.

The foregoing embodiments are illustrative in all points and should not be construed to limit the present invention. The scope of the present invention is defined not by the foregoing embodiment but by the following claims. Further, the scope of the present invention is intended to include all modifications within the meanings and scopes of claims and equivalents.

1. A filter unit for filtering liquid passing therethrough, comprising:
a first housing member having a bottomed tubular shape;
a second housing member having a bottomed tubular shape and liquid-tightly joined to the first housing member;
a filter member disposed so as to be sandwiched between the first housing member and the second housing member; and
an O-ring disposed so as to be sandwiched, together with the filter member, between the first housing member and the second housing member while contacting an end portion of the filter member, wherein:
the first housing member is formed with an annular projection located outside a portion of the first housing member which is contacted by the O-ring;
the second housing member is formed with an annular recess located to face the projection for receiving the projection therein; and
a sealing material is provided between the projection and the recess.

2. The filter unit according to claim 1, wherein the O-ring comprises:
a filter fixing portion contacting the end portion of the filter member; and
a sealing portion which is continuous with the filter fixing portion and extends outwardly along an interface between the first housing member and the second housing member.

3. The filter unit according to claim 2, wherein the O-ring has a substantially L-shaped section and is formed such that the filter fixing portion is thicker than the sealing portion.

4. The filter unit according to claim 3, wherein the first and second housing members are formed with a retainer portion in which the O-ring is fitted.

5. The filter unit according to claim 4, wherein:
the first and second housing members are formed from PEEK (polyether ether ketone); and
the O-ring is formed from perfluoro rubber.
